(19) United States
(12) Patent Application Publication
(10) Pub. No.: US 2025/0187136 A1
(43) Pub. Date: Jun. 12, 2025

(54) ENDPOINT DETECTION METHOD AND DEVICE FOR WAFER FILM GRINDING

(71) Applicant: BEIJING TSD SEMICONDUCTOR CO., LTD., Beijing (CN)

(72) Inventors: Weitao MENG, Beijing (CN); Jile JIANG, Beijing (CN)

(73) Assignee: BEIJING TSD SEMICONDUCTOR CO., LTD., Beijing (CN)

(21) Appl. No.: 19/060,272

(22) Filed: Feb. 21, 2025

Related U.S. Application Data
(63) Continuation of application No. PCT/CN2023/126417, filed on Oct. 25, 2023.

(30) Foreign Application Priority Data
Aug. 10, 2023 (CN) 202311002718.X

(51) Int. Cl. B24B 37/013

(52) U.S. Cl. CPC B24B 37/013

(57) ABSTRACT

Disclosed is an endpoint detection method and device for wafer film grinding in the technical field of semiconductors, the method including: obtaining a measured spectral curve of a correspondence between reflectance and wavelength of a wafer film during a grinding process of the wafer film; determining a plurality of feature points in the measured spectral curve; determining corresponding reference points in reference spectral curves based on wavelength values of the plurality of feature points; computing a cosine similarity between the measured spectral curve and each of the reference spectral curves based on the plurality of feature points and a plurality of reference points; determining a reference spectral curve matching the measured spectral curve based on the cosine similarity; and determining a current thickness of the wafer film based on a thickness corresponding to the matched reference spectral curve.

### CROSS-REFERENCE TO RELATED APPLICATIONS

The application claims priority to Chinese patent application No. 202311002718.X, filed on Aug. 10, 2023, the entire contents of which are incorporated herein by reference.

### TECHNICAL FIELD

The present invention relates to the technical field of semiconductors, and in particular, to an endpoint detection method and device for wafer film grinding.

### BACKGROUND

With the rapid development of the semiconductor industry, the feature sizes of integrated circuits continuously tend towards miniaturization; semiconductor chips continue to develop towards small size, high circuit density, fast speed, and low power consumption; and integrated circuits have reached the ULSI sub-micron technology level. As the diameter of a silicon wafer gradually increases, the width of scribed lines in the component gradually decreases, and the number of metal layers increases. Therefore, high polishing of the surface of a semiconductor film has an important impact on the high performance, low cost, and high yield of devices, leading to increasingly stringent requirements for the surface flatness of silicon wafers.

Chemical Mechanical Planarization (CMP) is a global surface planarization technology used to reduce the impact of substrate thickness changes and surface topography during a semiconductor manufacturing process. Since CMP can accurately and uniformly planarize a substrate to the required thickness and flatness, it has become the most widely used surface planarization technology in the semiconductor manufacturing process. The current mainstream technology is online endpoint detection, which can better control wafer film thickness changes, reduce repeated operations, and realize automated CMP operations, thereby increasing the utilization rate and output of the CMP device and reducing the density distribution defects of an IC device, reducing non-uniformity, and ultimately improving the stability and reliability of semiconductor devices. The principle of online endpoint detection technology is mainly based on detection through optical, electrical, acoustic or vibrational, thermal, frictional, chemical, or electrochemical means. In the monitoring process of a spectral endpoint detection method, it is first necessary to establish reference spectra under different film thicknesses within a defined wavelength range, and then match the spectrum measured in situ during a CMP process with a reference spectrum library through a set matching method to find the best matching reference spectrum. The film thickness corresponding to the best matching reference spectrum is used as the film thickness during the CMP process.

Since the measurement environment for in-situ online measurement during an actual CMP process is relatively harsh and will be affected by various factors, for example, systematic errors inevitably caused by spectra and random errors caused by measurement conditions such as ambient light and probe distance jitter. Especially during CMP of multi-layer films, external factors will cause compression, elevation, and parallel displacement differences in the measured reflectance curve, and may also cause loss of information in some wavelength ranges, which will subsequently result in that the measured reflectance curve cannot match the theoretical curve well, thus leading to a decrease in the accuracy of the final measured value of the film thickness.

### SUMMARY

According to a first aspect of the embodiments of the present application, an online thickness detection method for wafer film grinding is provided, including the following steps:
obtaining a measured spectral curve of a correspondence between reflectance and wavelength of a wafer film during a grinding process of the wafer film; determining a plurality of feature points in the measured spectral curve; determining corresponding reference points in reference spectral curves based on wavelength values of the plurality of feature points; computing a cosine similarity between the measured spectral curve and each of the reference spectral curves based on the plurality of feature points and a plurality of reference points; determining a reference spectral curve matching the measured spectral curve based on the cosine similarity; and determining a current thickness of the wafer film based on a thickness corresponding to the matched reference spectral curve.

Optionally, the step of determining a plurality of feature points in the measured spectral curve includes: determining points with abnormal fluctuations based on reflectance of each point in the measured spectral curve and adjacent points thereof; and taking a preset number of points from points in the measured spectral curve except for the points with abnormal fluctuations as the feature points.

Optionally, the step of determining a plurality of feature points in the measured spectral curve includes: determining at least one critical point based on a change rate of each point in the measured spectral curve so that the measured spectral curve is divided into at least two bands; and selecting a corresponding preset number of points in each of the bands as the feature points, where the preset number of points corresponding to a band with a higher change rate is greater than the preset number of points corresponding to a band with a lower change rate.

Optionally, the reference spectral curve is a theoretical spectral curve of a correspondence between theoretical reflectance and wavelength computed based on a refractive index of the wafer film and a pre-detected film thickness range.

Optionally, in the step of computing a cosine similarity between the measured spectral curve and each of the reference spectral curves, the cosine similarity between the measured spectral curve and the reference spectral curves is computed as follows:

$$cos θ = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}}$$

where cos θ represents the cosine similarity; Aᵢ represents reflectance of an i^{th} feature point in the measured spectral curve; Bᵢ represents reflectance of an i^{th} reference point in the reference spectral curve; and n represents the number of feature points and reference points.

Optionally, the step of computing a cosine similarity between the measured spectral curve and each of the reference spectral curves includes: processing the plurality of feature points and the plurality of reference points; and computing the cosine similarity based on the processed plurality of feature points and the processed plurality of reference points to obtain a computed result in an interval of [−1,1].

Optionally, the step of processing the plurality of feature points and the plurality of reference points includes: computing mean measured reflectance of the plurality of feature points and mean reference reflectance of the plurality of reference points; and subtracting the mean measured reflectance from reflectance of each of the feature points, and the mean reference reflectance from reflectance of each of the reference points.

Optionally, the cosine similarity is computed as follows:

$${cos}^{′} θ = \frac{{\sum }_{i = 1}^{n} {\hat{A}}_{i} \times {\hat{B}}_{i}}{\sqrt{{\sum }_{i = 1}^{n} {( {\hat{A}}_{i} )}^{2}} \times \sqrt{{\sum }_{i = 1}^{n} {( {\hat{B}}_{i} )}^{2}}}$$

$${\hat{A}}_{i} = {A}_{i} − \frac{1}{n} {\sum }_{i = 1}^{n} {A}_{i}$$

$${\hat{B}}_{i} = {B}_{i} − \frac{1}{n} {\sum }_{i = 1}^{n} {B}_{i}$$

where cos′ θ represents the cosine similarity; Âᵢ represents a result of subtracting the mean measured reflectance from the reflectance of the i^{th} feature point in the measured spectral curve; \hat{B}ᵢ represents a result of subtracting the mean reference reflectance from the reflectance of the i^{th} reference point in the reference spectral curve; Aᵢ represents the reflectance of the i^{th} feature point in the measured spectral curve; Bᵢ represents the reflectance of the i^{th} reference point in the reference spectral curve; and n represents the number of feature points and reference points.

Optionally, the wafer film is a multi-layer film.

Optionally, the feature points include all data points in the measured spectral curve.

Optionally, the number of feature points is a preset number.

Optionally, the number of feature points is a number determined in real time according to characteristics of the measured spectral curve.

Optionally, the plurality of feature points are evenly distributed on the measured spectral curve; and the step of determining a plurality of feature points in the measured spectral curve includes: uniformly selecting the plurality of feature points based on a wavelength range of the measured spectral curve and a preset number of feature points.

Optionally, the plurality of feature points are located in a band with relatively rich feature information in the measured spectral curve.

Optionally, the reference spectral curve matching the measured spectral curve refers to a reference spectral curve with the cosine similarity closest to 1.

Optionally, the reference spectral curves are collected in advance, and parameters used during collection of the reference spectral curves are the same as those used during collection of the measured spectral curve, where the parameters include a wavelength range, a wavelength resolution, and a reflectance resolution.

Optionally, each of the reference spectral curves is a reflectance-wavelength reference spectral curve that is established in advance based on reflectance of the wafer film and the pre-detected film thickness range and includes a defined wavelength range under several different thicknesses of the wafer film.

Optionally, before the step of determining a plurality of feature points in the measured spectral curve, the method further includes: filtering the measured spectral curve to filter out noise caused by a grinding environment during the grinding process, where a method for the filtering is any one of wavelet filtering, Fourier filtering, and sliding window average filtering.

According to a second aspect of the embodiments of the present application, an endpoint detection method for wafer film grinding is further provided, including: using the online thickness detection method described above to monitor in real time whether a thickness of a wafer film reaches a target thickness; and stopping grinding when the thickness of the wafer film reaches the target thickness.

According to a third aspect of the embodiments of the present application, an online thickness detection device for wafer film grinding is further provided, including: a processor and a memory connected to the processor, where the memory stores instructions that can be executed by the processor, and the instructions are executed by the processor to cause the processor to perform the online thickness detection method for wafer film grinding described above.

According to a fourth aspect of the embodiments of the present application, an endpoint detection device for wafer film grinding is further provided, including: a processor and a memory connected to the processor, where the memory stores instructions that can be executed by the processor, and the instructions are executed by the processor to cause the processor to perform the endpoint detection method for wafer film grinding described above.

According to the online thickness detection method and device for wafer film grinding provided by the present invention, the current thickness of the wafer film is determined by computing the cosine similarity between the measured spectral curve and the reference spectral curve, which can better reduce problems such as compression and elevation of the measured curve caused by multi-layer films and a decrease in the matching degree caused by parallel displacement differences; moreover, the time required to match the in-situ measurement with the reference curve is short, thereby achieving real-time in-situ measurement. The present invention selects the cosine similarity as a scoring function since the evaluation method of the cosine similarity is sensitive to waveforms, and the cosine similarity of two parallel curves in a two-dimensional space is 1, which is suitable for an actual measurement situation herein. Therefore, the selection of the cosine similarity as the scoring function to evaluate a similarity in the case of multi-layer dielectrics improves the accuracy of online thickness detection of a wafer film.

### BRIEF DESCRIPTION OF THE DRAWINGS

To describe the technical solutions in the embodiments of the present invention or in the prior art more clearly, the following briefly describes the accompanying drawings needed for describing the embodiments or the prior art. Apparently, the accompanying drawings in the following description show some embodiments of the present invention, and those of ordinary skill in the art may further derive other accompanying drawings from these accompanying drawings without making creative efforts.

FIG. 1 is a schematic flowchart of an online thickness detection method for wafer film grinding provided in an embodiment of the present application;

FIG. 2 is a schematic diagram of a measured spectral curve and a reference spectral curve provided in an embodiment of the present invention;

FIG. 3 is a schematic diagram of another measured spectral curve and another reference spectral curve provided in an embodiment of the present invention;

FIG. 4 is a schematic matching graph between a measured reflectance-wavelength curve and a reflectance-wavelength curve in a reference curve library after matching analysis of a cosine similarity provided in an embodiment of the present invention;

FIG. 5 is another schematic matching graph between a measured reflectance-wavelength curve and a reflectance-wavelength curve in a reference curve library after matching analysis of a cosine similarity provided in an embodiment of the present invention;

FIG. 6 is a schematic matching graph between a measured reflectance-wavelength curve and a reflectance-wavelength curve in a reference curve library after matching analysis of a mean square error provided in an embodiment of the present invention; and

FIG. 7 is a schematic flowchart of an endpoint detection method for wafer film grinding provided in an embodiment of the present application.

### DETAILED DESCRIPTION OF THE EMBODIMENTS

An explicit and complete description of the technical solutions in the present invention will be given below in conjunction with the accompanying drawings. Apparently, the described embodiments are part, but not all, of the embodiments of the present invention. Based on the embodiments in the present invention, all other embodiments obtained by those of ordinary skill in the art without making creative efforts shall fall within the protection scope of the present invention.

In addition, the technical features involved in different embodiments of the present invention described below can be combined with each other as long as they do not conflict with each other.

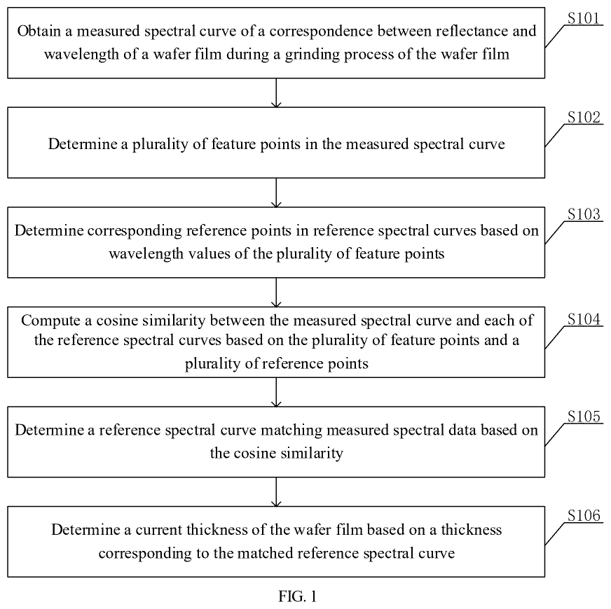

As shown in FIG. 1, an online thickness detection method for a silicon dioxide wafer film during a grinding process of the silicon-based silicon dioxide wafer film can be executed by an electronic device such as a computer or server, including the following steps:

S101: obtaining a measured spectral curve of a correspondence between reflectance and wavelength of the silicon-based silicon dioxide wafer film during the grinding process of the silicon-based silicon dioxide wafer film. The reflectance of the silicon dioxide wafer in a defined wavelength range during the grinding process is measured in real time through a spectrometer, and during real-time measurement, the dielectrics that the incident light of the spectrometer encounters are air, glass, PU, a slurry, silicon dioxide, and silicon in sequence.

The spectrometer outputs a reflectance-wavelength curve in the defined wavelength range under a current thickness of the wafer film in real time. In an embodiment, the defined wavelength range is 400-1,000 nm, the wavelength resolution is 0.8 nm; the reflectance resolution is 1*10*\hat{ }−4; and the spectral curve acquisition time interval is 100 ms.

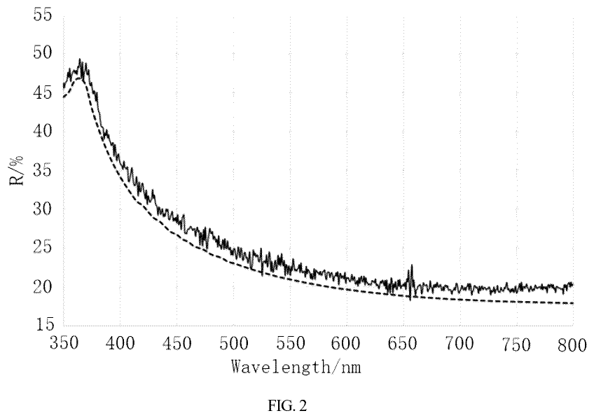

As shown in FIG. 2, the relatively rough curve above is the measured spectral curve, the horizontal axis represents the wavelength, and the vertical axis represents the reflectance.

S102: determining a plurality of feature points in the measured spectral curve. These feature points may be automatically selected according to a certain rule (such as local extreme points, or jump points), or manually specified. The number of feature points may be fixed or determined in real time according to characteristics of a current curve. In some embodiments, these feature points are evenly distributed on the curve. When the operation of selecting feature points is performed, the feature points can be selected evenly from the curve according to a wavelength range of the curve and a preset number of feature points.

Or, the plurality of feature points are determined in the measured spectral curve. These feature points may be all data points in the measured spectral curve, or some data points automatically selected according to a certain rule (such as local extreme points, or jump points), or some data points specified manually. The number of feature points may be fixed (a preset number), or determined in real time according to characteristics of a current curve. In some embodiments, these feature points are evenly distributed on the curve. When the operation of selecting feature points is performed, the feature points can be selected evenly from the curve according to a wavelength range of the curve and a preset number of feature points.

Regarding the selection of feature points, on the one hand, the number of feature points is large enough, for example, hundreds; on the other hand, the positions of the feature points on the curve, for example, in a band with relatively rich feature information. Enough feature points are selected within a suitable wavelength range so that subsequently computed data can accurately reflect the characteristics of the spectral curve.

It can be seen from the example shown in FIG. 2 that there may be noise interfering with the data points in the measured spectral curve, such as reflectance fluctuations around the wavelength of 670 nm. These data points can be called points with abnormal fluctuations, and when they are included in the selected feature points, it may interfere with the accuracy of subsequently computed data and fail to accurately reflect the characteristics of the measured spectral curve.

In order to solve the above possible problems, in an embodiment, after obtaining the measured spectral curve, points with abnormal fluctuations are determined first based on reflectance of each point and adjacent points thereof, and then the points with abnormal fluctuations are removed during the selection of feature points, and a preset number of points are taken from other normal data points as the feature points.

It can be found from the measured spectral curves at various thicknesses that feature information of a short-wave band is richer than that of a long-wave band. Taking FIG. 2 as an example, the feature information of the band before the wavelength of 550 nm is richer than that of the band thereafter. According to this characteristic, in order to make the subsequently computed data more accurately reflect the characteristics of the spectral curve, in an embodiment, after obtaining the measured spectral curve, at least one critical point is first determined based on a change rate of each point on the measured spectral curve. For example, the wavelength of 550 nm in FIG. 2 is the critical point. Specifically, a certain clustering algorithm can be used to determine the critical point. In actual applications, since spectral curves of different grinding materials exhibit different characteristics, an appropriate number of critical points can be set in advance according to the characteristics shown by the reference spectral curve.

These critical points cause the measured spectral curve to be divided into at least two bands, i.e. the curve is divided into two bands in the case of one critical point, three bands in the case of two critical points, and so on. A corresponding number of feature points selected for each band is set in advance, and the preset number corresponding to a band with a higher change rate is greater than the preset number corresponding to a band with a lower change rate. For example, as shown in FIG. 2, the preset number corresponding to the band with a wavelength smaller than 550 nm is greater than the preset number corresponding to the band with a wavelength larger than 550 nm.

After obtaining the critical points and bands, a corresponding preset number of points are selected from each band as the feature points so that the selection density of feature points in a band with richer feature information is greater, thereby improving the accuracy of subsequently computed data, and thus improving thickness detection accuracy.

It should be noted that the above two methods of selecting feature points can be used simultaneously. For example, the points with abnormal fluctuations are excluded first, following which the above critical points are determined, and then different numbers of feature points are selected from different bands.

S103: determining corresponding reference points in reference spectral curves based on wavelength values of the plurality of feature points. The reference spectral curves are collected in advance, and parameters used during collection of the reference spectral curves are the same as those used during collection of the measured spectral curve. That is to say, the same wavelength range, wavelength resolution, and reflectance resolution are used.

Specifically, a reference curve library of reflectance-wavelength reference spectral curves including a defined wavelength range under several different thicknesses of the wafer film can be established in advance based on reflectance n of the wafer film and the pre-detected film thickness range d. In an embodiment, the defined wavelength range is 400-1,000 nm; the wavelength resolution is 0.8 nm; the reflectance resolution is 1*10*\hat{ }−4 (the same parameters used to collect the measured spectral curve); the pre-detected film thickness range d is 200-800 nm; and the film thickness resolution is 0.1 nm, that is, a corresponding reflectance-wavelength spectral curve is established every 0.1 nm.

In this way, the spectral curve of a wafer film with a known thickness can be obtained. For example, for a wafer film with a known thickness of d1, the spectral curve of a correspondence between reflectance and wavelength thereof is obtained . . . for a wafer film with a known thickness of dn, the spectral curve of a correspondence between reflectance and wavelength thereof is obtained, and the resulting spectral curves are called reference spectral curves. A collection of these reference spectral curves is called a reference curve library.

As shown in FIG. 2, the relatively smooth curve below is the reference spectral curve, the horizontal axis represents the wavelength, and the vertical axis represents the reflectance. The reference points corresponding to the feature points refer to two points with the same wavelength on the two curves, that is, the two points with the same x-coordinate value.

S104: computing a cosine similarity between the measured spectral curve and each of the reference spectral curves based on the plurality of feature points and a plurality of reference points. The feature points (or reference points) contain two pieces of information: wavelength and reflectance. In the embodiment shown in FIG. 2, the y-coordinate of the feature point on the measured spectral curve represents reflectance, and the x-coordinate thereof represents wavelength. Similarly, the y-coordinate of the reference point on each of the reference spectral curves represents reflectance and the x-coordinate thereof represents wavelength. A vector can be determined based on the coordinates of the feature point. Similarly, a vector can also be determined based on the coordinates of the reference point, and the cosine similarity between the two curves can be obtained by computing the cosine value of the angle between the two vectors.

S105: determining a reference spectral curve matching the measured spectral curve based on the cosine similarity. Specifically, a reference spectral curve with the cosine similarity closest to 1 can be taken as the curve matching the measured spectral curve.

S106: determining a current thickness of the wafer film based on a thickness corresponding to the matched reference spectral curve. For example, if the thickness corresponding to the matched reference spectral curve is di, it can be determined that di is the current thickness of the wafer film.

In this embodiment, the current thickness of the wafer film is determined by computing the cosine similarity between the measured spectral curve and the reference spectral curve, which can better reduce problems such as compression and elevation of the measured curve caused by multi-layer films and a harsh grinding environment, and a decrease in the matching degree caused by parallel displacement differences; moreover, the time required to match the in-situ measurement with the reference curve is short, thereby achieving real-time in-situ measurement. It only takes 400 ms from real-time collection to obtaining the final film thickness. This embodiment selects the cosine similarity as a scoring function since the evaluation method of the cosine similarity is sensitive to waveforms, and it is determined whether the cosine similarity of two parallel curves in a two-dimensional space is 1, which is relatively consistent with an actual measurement situation. Therefore, the selection of the cosine similarity as the scoring function to evaluate a similarity in the case of multi-layer dielectrics improves the accuracy of online thickness detection of a wafer film.

Before the step S102, the measured spectral curve can be filtered to filter out noise caused by a grinding environment during the grinding process. Methods for the filtering include, but are not limited to, wavelet filtering, Fourier filtering, and sliding window average filtering.

This embodiment improves the accuracy of the measured spectral curve by filtering the noise caused by the grinding environment during the grinding process, thereby improving the accuracy of the thickness of the wafer film.

In a preferred embodiment, the step of S102: determining a plurality of feature points in the measured spectral curve includes:
obtaining a preset number of feature points; and
selecting the plurality of feature points evenly from the measured spectral curve based on the preset number of feature points and a wavelength range in the measured spectral curve.

This embodiment selects the preset number of feature points within the same wavelength range as the reference curve to compute the cosine similarity of the feature points within the same wavelength range, thereby improving the accuracy of computation and also improving the accuracy of the thickness of the wafer film.

In an embodiment, the cosine similarity is computed as follows in the step S104:

$$cos θ = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}}$$

where cos θ represents the cosine similarity; Aᵢ represents reflectance of an i^{th} feature point in the measured spectral curve; Bᵢ represents reflectance of an i^{th} reference point in the reference spectral curve; and n represents the number of feature points and reference points.

Among the 800 selected feature points and reference points, the reflectance of some points is shown in the following table:

| | | | | | | |
|---|---|---|---|---|---|---|
| 36.6152 | 36.5003 | 36.7133 | 36.9408 | 35.8994 | 35.7367 | 37.674 |
| 27.19665 | 27.15587 | 27.11817 | 27.08163 | 27.04466 | 27.00726 | 26.96954 |

| | | | | | | |
|---|---|---|---|---|---|---|
| 36.8675 | 37.0135 | 37.5286 | 37.3384 | 36.7393 | 36.0644 | 37.7581 |
| 26.93169 | 26.8935 | 26.85504 | 26.81635 | 26.78159 | 26.74872 | 26.71581 |

where the data in the upper line Aᵢ represent the reflectance of the i^{th} feature point in the measured spectral curve; and the data in the lower line Bᵢ represent the reflectance of an i^{th} reference point in the reference spectral curve. Due to the large amount of data, only the values of the first 14 points are shown here.

The cosine similarity between the two curves is computed as follows:

$$cos θ = \frac{36.6 * 27.1 + 36.5 * 27.1 + 36.9 * 27. … …}{\sqrt{{36.6}^{2} + {36.5}^{2} + {36.9}^{2} + …} + \sqrt{{27.1}^{2} + {27.1}^{2} + {27.}^{2} + …}} = 0.84$$

According to the above computational formula, the cosine similarity between the measured spectral curve and each reference spectral curve is obtained, and a reference spectral curve with the cosine similarity closest to 1 is taken as the curve matching the measured spectral curve.

This embodiment only uses reflectance when computing the cosine similarity, thereby reducing the computation burden and the matching computation time, further enhancing the real-time performance of film thickness measurement.

To further improve accuracy, in an embodiment, the cosine similarity is computed as follows in the step S104:
computing mean measured reflectance of the plurality of feature points and mean reference reflectance of the plurality of reference points; and
subtracting the mean measured reflectance from reflectance of each of the feature points, and the mean reference from reflectance of each of the reference points; and
computing the cosine similarity based on results of subtraction to obtain a computed result in an interval of [−1,1], where the computational formula is as follows:

$${cos}^{′} θ = \frac{{\sum }_{i = 1}^{n} {\hat{A}}_{i} \times {\hat{B}}_{i}}{\sqrt{{\sum }_{i = 1}^{n} {( {\hat{A}}_{i} )}^{2}} \times \sqrt{{\sum }_{i = 1}^{n} {( {\hat{B}}_{i} )}^{2}}}$$

$${\hat{A}}_{i} = {A}_{i} − \frac{1}{n} {\sum }_{i = 1}^{n} {A}_{i}$$

$${\hat{B}}_{i} = {B}_{i} − \frac{1}{n} {\sum }_{i = 1}^{n} {B}_{i}$$

where cos′ θ represents the cosine similarity; Âᵢ represents a result of subtracting the mean measured reflectance from the reflectance of the i^{th} feature point in the measured spectral curve; \hat{B}ᵢ represents a result of subtracting the mean reference reflectance from the reflectance of the i^{th} reference point in the reference spectral curve; Aᵢ represents the reflectance of the i^{th} feature point in the measured spectral curve; Bᵢ represents the reflectance of the i^{th} reference point in the reference spectral curve; and n represents the number of feature points and reference points.

Since vectors of the reflectance curve are all represented in the first quadrant of a plane coordinate system, no matter how different the reflectance curve is from the theoretical value, the value range of cosine similarity is in [0,1], and the value range [−1,0] of cosine similarity is not fully utilized. The operation of mean subtraction is performed in both the measured value and the theoretical value libraries so that the measured value and theoretical value curves may exist in the first or second quadrant simultaneously, and at this time, the evaluation value range of cosine similarity is fully utilized to expand the difference in cosine similarity scores between the two curves that are actually quite different.

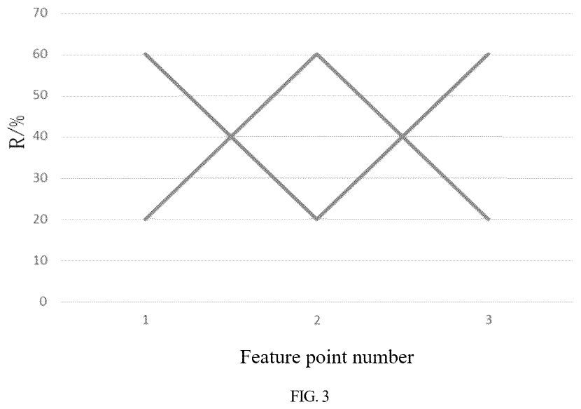

Here is a more extreme example: if there are two curves with the line segment at each feature point close to 90°, the waveform features are shown in FIG. 3, and the reflectance of the feature point and the reference point selected from the two curves respectively are as follows:

| | | | |
|---|---|---|---|
| Reflectance of the feature point | 20 | 60 | 20 |
| Reflectance of the reference point | 60 | 20 | 60 |

If the data is not subjected to mean subtraction, the cosine similarity is as follows:

$${cos}^{′} θ = \frac{20 * 60 + 60 * 20 + 20 * 60}{\sqrt{{20}^{2} + 6 {0}^{2} + 2 {0}^{2}} * \sqrt{{60}^{2} + 2 {0}^{2} + 6 {0}^{2}}} = 0.65$$

It is not a value close to −1 as expected since the line segment at each feature point is not mapped to the origin. Therefore, the cosine similarity cannot reflect the angle therebetween.

The corresponding mean is subtracted from the feature point and the reference point respectively in the above processing manner:

| | | | |
|---|---|---|---|
| Reflectance of the feature point − mean | −13 | 27 | −13 |
| Reflectance of the reference point − mean | 10 | −30 | 10 |

Then, the cosine similarity is as follows:

$${cos}^{′} θ = \frac{- 13 * 10 + 27 * - 30 - 13 * 10}{\sqrt{1 {3}^{2} + 2 {7}^{2} + 1 {3}^{2}} * \sqrt{{10}^{2} + 3 {0}^{2} + {10}^{2}}} \approx - 0.97$$

The cosine similarity computed thereby is negative, which can better reflect an extremely low similarity between the two curves using a larger value range [−1,1], and can also better reflect a similarity between the two curves, thereby improving the accuracy of matching between the measured spectral curve and the reference spectral curve.

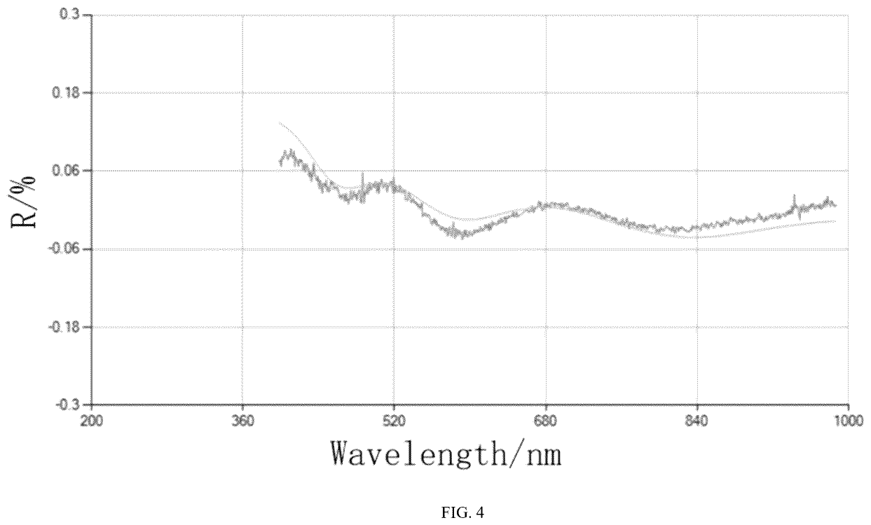

As shown in FIG. 4, the curve with larger jitter represents the measured reflectance-wavelength curve at a current time, and the smooth straight line represents the reference reflectance-wavelength curve in the reference curve library that best matches the measured curve. The film thickness represented by the reflectance-wavelength curve in the reference curve library obtained according to the method of the above embodiment was 706.9 nm, and the accuracy of film thickness measurement was verified by actually stopping the grinding machine and selecting 49 points on a to-be-ground wafer for film thickness measurement with the Otsuka optical thickness meter OPTM: the maximum value was measured at 711.32 nm, and the minimum value was measured at 695.14 nm. The measured data were within the true film thickness range, verifying the accuracy of the algorithm,

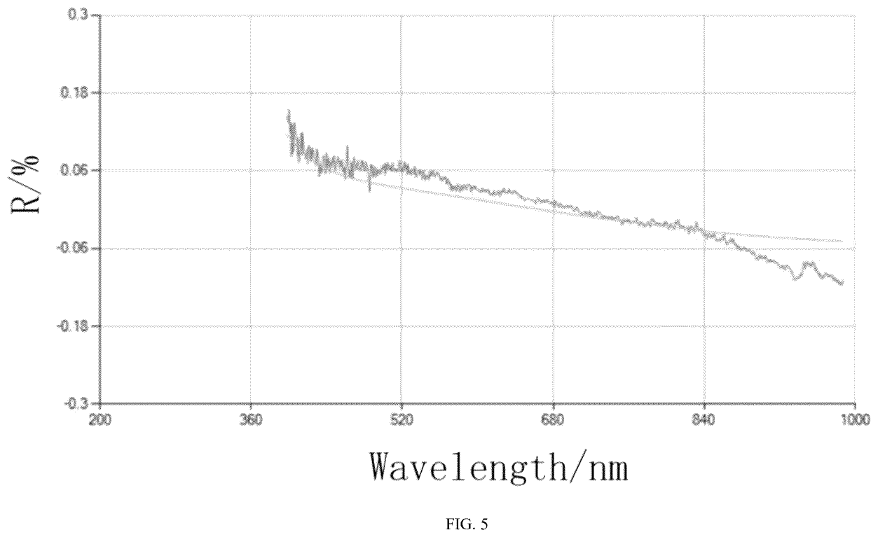

As shown in FIG. 5, the curve with greater jitter represents the measured reflectance-wavelength curve at a current moment, and the smooth straight line represents the reference reflectance-wavelength curve in the reference curve library that best matches the measured curve. At this time, the film thickness represented by the reflectance-wavelength curve in the reference curve library obtained according to the method of the above embodiment was 197.4 nm, and the accuracy of film thickness measurement was verified by actually stopping the grinding machine and selecting 49 points on a to-be-ground wafer for film thickness measurement with the Otsuka optical thickness meter OPTM: the maximum value was measured at 200.30 nm, and the minimum value was measured at 195.13 nm. The measured data were within the true film thickness range, verifying the accuracy of the algorithm,

In order to further highlight the beneficial effects brought by the present invention, this embodiment provides a comparative example using a mean squared error (MSE) as the matching algorithm evaluation function (this method mainly uses a distance between two curves as the evaluation criterion, and the smaller the distance, the more similar the two curves are). The specific computational formula is as follows:

$$MSE = {\sum }_{i = 1}^{n} {( {A}_{i} - {B}_{i} )}^{2}$$

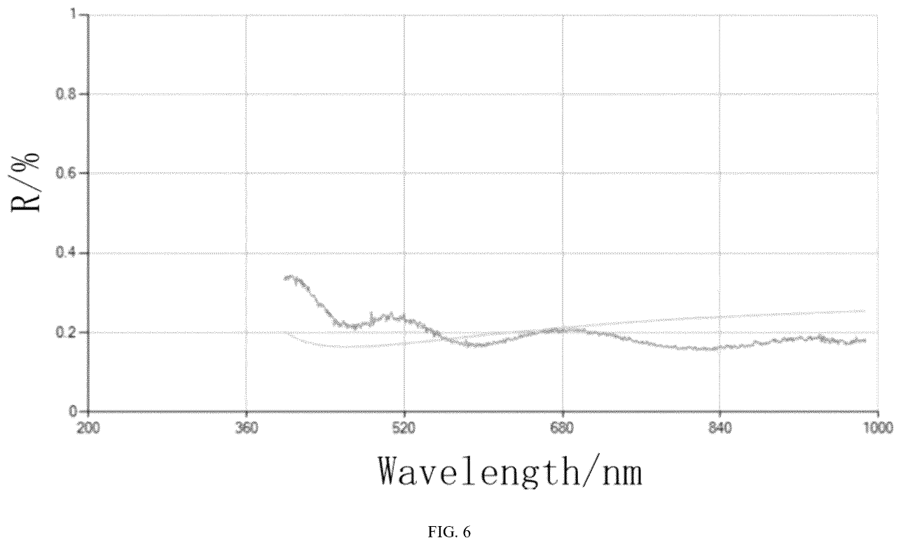

Except for S103-S105, the other steps are the same. At a certain time during grinding, real-time film thickness measurement was performed according to the above process, and the final matching graph is shown in FIG. 6, in which the curve with greater jitter represents the measured reflectance-wavelength curve at a current moment, and the smooth straight line represents the reference reflectance-wavelength curve in the reference curve library that best matches the measured curve. At this time, the film thickness represented by the reflectance-wavelength curve in the reference curve library was 64.2 nm. 49 points were selected on a to-be-ground wafer for film thickness measurement with the Otsuka optical thickness meter OPTM: the maximum value was measured at 688 nm, and the minimum value was measured at 695.13 nm. It can be seen that this matching method cannot accurately measure film thickness during a grinding process.

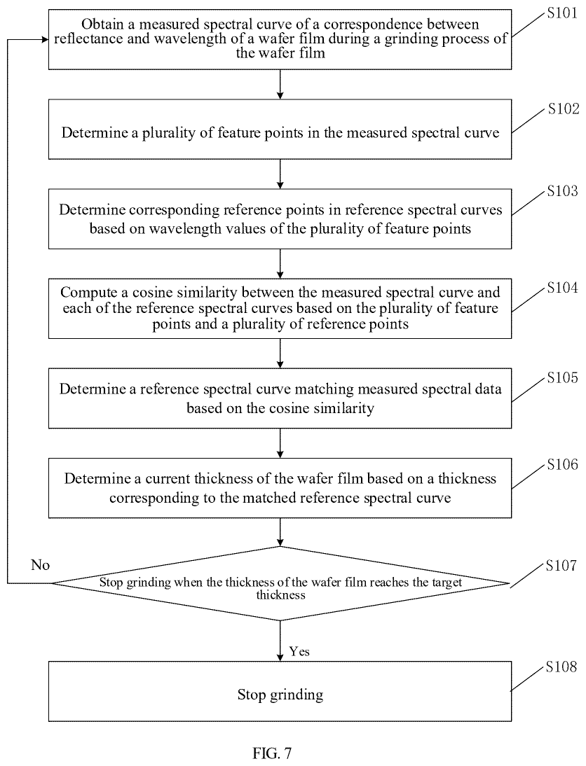

As shown in FIG. 7, an embodiment of the present invention provides an endpoint detection method for wafer film grinding, which can be executed by an electronic device such as a computer or serve, including the following operation steps:
measuring a thickness of a wafer film in real time through the steps S101-S106 of the online thickness detection method in the above embodiments;

S107: determining whether the thickness of the wafer film reaches a target thickness, and when the thickness of the wafer film reaches the target thickness, performing a step S108; otherwise, continuing grinding and returning to the step S101; and

S108: stop grinding.

In this embodiment, since the reference spectral curve matched by cosine similarity is highly accurate, the obtained real-time thickness of the wafer film is accurate, and grinding is stopped timely when a current thickness reaches the target thickness, thereby improving the accuracy of wafer grinding.

Those skilled in the art should understand that the embodiments of the present invention may be provided as a method, a system, or a computer program product. Therefore, the present invention may be in the form of a hardware-only embodiment, a software-only embodiment, or an embodiment with a combination of software and hardware. Moreover, the present invention may be in the form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that a computer program instruction may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may be stored in a computer readable memory that can instruct the computer or another programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operation steps are performed on the computer or another programmable device to generate computer-implemented processing. Therefore, the instructions executed on the computer or another programmable device are used to provide steps for implementing a specific function in one or more processes in the flowcharts and/or in one or more blocks in the block diagrams.

Obviously, the above embodiments are merely examples for clear description, rather than limit the implementation. For those of ordinary skill in the art, other changes or modifications in different forms can be made on the basis of the above description. It is neither necessary nor impossible to exhaust all the embodiments herein. However, any obvious changes or modifications derived thereof still fall within the protection scope of the present invention.

What is claimed is:

1. An online thickness detection method for wafer film grinding, comprising the following steps:
obtaining a measured spectral curve of a correspondence between reflectance and wavelength of a wafer film during a grinding process of the wafer film;
determining a plurality of feature points in the measured spectral curve;
determining corresponding reference points in reference spectral curves based on wavelength values of the plurality of feature points;
computing a cosine similarity between the measured spectral curve and each of the reference spectral curves based on the plurality of feature points and a plurality of reference points;
determining a reference spectral curve matching the measured spectral curve based on the cosine similarity; and
determining a current thickness of the wafer film based on a thickness corresponding to the matched reference spectral curve.

2. The online thickness detection method of claim 1, wherein the step of determining a plurality of feature points in the measured spectral curve comprises:
determining points with abnormal fluctuations based on reflectance of each point in the measured spectral curve and adjacent points thereof, and
taking a preset number of points from points in the measured spectral curve except for the points with abnormal fluctuations as the feature points.

3. The online thickness detection method of claim 1, wherein the step of determining a plurality of feature points in the measured spectral curve comprises:
determining at least one critical point based on a change rate of each point in the measured spectral curve so that the measured spectral curve is divided into at least two bands; and
selecting a corresponding preset number of points in each of the bands as the feature points, wherein the preset number of points corresponding to a band with a higher change rate is greater than the preset number of points corresponding to a band with a lower change rate.

4. The online thickness detection method of claim 1, wherein in the step of computing a cosine similarity between the measured spectral curve and each of the reference spectral curves, the cosine similarity between the measured spectral curve and the reference spectral curves is computed as follows:
$$cos θ = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}}$$
wherein cos θ represents the cosine similarity; Aᵢ represents reflectance of an i^{th} feature point in the measured spectral curve; Bᵢ represents reflectance of an i^{th} reference point in the reference spectral curve; and n represents the number of feature points and reference points.

5. The online thickness detection method of claim 1, wherein the step of computing a cosine similarity between the measured spectral curve and each of the reference spectral curves comprises:
processing the plurality of feature points and the plurality of reference points; and
computing the cosine similarity based on the processed plurality of feature points and the processed plurality of reference points to obtain a computed result in an interval of [−1,1].

6. The online thickness detection method of claim 5, wherein the step of processing the plurality of feature points and the plurality of reference points comprises:
computing mean measured reflectance of the plurality of feature points and mean reference reflectance of the plurality of reference points; and
subtracting the mean measured reflectance from reflectance of each of the feature points, and the mean reference reflectance from reflectance of each of the reference points.

7. The online thickness detection method of claim 6, wherein the cosine similarity is computed as follows:
$${cos}^{′} θ = \frac{{\sum }_{i = 1}^{n} {\hat{A}}_{i} \times {\hat{B}}_{i}}{\sqrt{{\sum }_{i = 1}^{n} {( {\hat{A}}_{i} )}^{2}} \times \sqrt{{\sum }_{i = 1}^{n} {( {\hat{B}}_{i} )}^{2}}}$$
$${\hat{A}}_{i} = {A}_{i} − \frac{1}{n} {\sum }_{i = 1}^{n} {A}_{i}$$
$${\hat{B}}_{i} = {B}_{i} − \frac{1}{n} {\sum }_{i = 1}^{n} {B}_{i}$$
wherein cos′ θ represents the cosine similarity; Âᵢ represents a result of subtracting the mean measured reflectance from the reflectance of the i^{th} feature point in the measured spectral curve; \hat{B}ᵢ represents a result of subtracting the mean reference reflectance from the reflectance of the i^{th} reference point in the reference spectral curve; Aᵢ represents the reflectance of the i^{th} feature point in the measured spectral curve; Bᵢ represents the reflectance of the i^{th} reference point in the reference spectral curve; and n represents the number of feature points and reference points.

8. The online thickness detection method of claim 1, wherein the wafer film is a multi-layer film.

9. The online thickness detection method of claim 1, wherein the feature points comprise all data points in the measured spectral curve.

10. The online thickness detection method of claim 1, wherein the number of feature points is a preset number.

11. The online thickness detection method of claim 1, wherein the number of feature points is a number determined in real time according to characteristics of the measured spectral curve.

12. The online thickness detection method of claim 1, wherein the plurality of feature points are evenly distributed on the measured spectral curve; and the step of determining a plurality of feature points in the measured spectral curve comprises: uniformly selecting the plurality of feature points based on a wavelength range of the measured spectral curve and a preset number of feature points.

13. The online thickness detection method of claim 1, wherein the plurality of feature points are located in a band with relatively rich feature information in the measured spectral curve.

14. The online thickness detection method of claim 1, wherein the reference spectral curve matching the measured spectral curve refers to a reference spectral curve with the cosine similarity closest to 1.

15. The online thickness detection method of claim 1, wherein the reference spectral curves are collected in advance, and parameters used during collection of the reference spectral curves are the same as those used during collection of the measured spectral curve, wherein the parameters comprise a wavelength range, a wavelength resolution, and a reflectance resolution.

16. The online thickness detection method of claim 1, wherein each of the reference spectral curves is a reflectance-wavelength reference spectral curve that is established in advance based on reflectance of the wafer film and the pre-detected film thickness range and comprises a defined wavelength range under several different thicknesses of the wafer film.

17. The online thickness detection method of claim 1, wherein before the step of determining a plurality of feature points in the measured spectral curve, the method further comprises:
filtering the measured spectral curve to filter out noise caused by a grinding environment during the grinding process, wherein a method for the filtering is any one of wavelet filtering, Fourier filtering, and sliding window average filtering.

18. An endpoint detection method for wafer film grinding, comprising the following steps:
using the online thickness detection method according to claim 1 to monitor in real time whether a thickness of a wafer film reaches a target thickness; and
stopping grinding when the thickness of the wafer film reaches the target thickness.

19. An online thickness detection device for wafer film grinding, comprising: a processor and a memory connected to the processor, wherein the memory stores instructions that can be executed by the processor, and the instructions are executed by the processor to cause the processor to perform the online thickness detection method for wafer film grinding according to claim 1.

20. An endpoint detection device for wafer film grinding, comprising: a processor and a memory connected to the processor, wherein the memory stores instructions that can be executed by the processor, and the instructions are executed by the processor to cause the processor to perform the endpoint detection method for wafer film grinding according to claim 18.
